(19) United States
(12) Patent Application Publication
(10) Pub. No.: US 2008/0159731 A1
(43) Pub. Date: Jul. 3, 2008

(54) IMAGE PHOTOGRAPHING APPARATUS

(75) Inventors: Byeong-su KIM, Suwon-si (KR); Yeon-moo Chung, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/865,917

(22) Filed: Oct. 2, 2007

(30) Foreign Application Priority Data
Dec. 28, 2006 (KR) 2006-136988

(51) Int. Cl. G03B 17/00; H04N 5/225

(52) U.S. Cl. 396/423; 348/376; 348/E05.024

(57) ABSTRACT

An image photographing apparatus includes a main body, a first button manipulation unit placed on the main body to be used in a high angle photographing operation, and a second button manipulation unit placed on the main body to be used in a low angle photographing operation.

### CROSS-REFERENCE TO RELATED APPLICATIONS

This application claims priority under 35 U.S.C. § 119 from Korean Patent Application No. 10-2006-0136988, filed on Dec. 28, 2006, in the Korean Intellectual Property Office, the entire content of which is incorporated herein by reference.

### BACKGROUND OF THE INVENTION

1. Field of the Invention

The present general inventive concept relates to an image photographing apparatus, such as a camcorder, a motion image camera, a still camera, or the like.

2. Description of the Related Art

As illustrated in FIG. 1, a conventional image photographing apparatus has a main body 10 and a hand grip 20 fixed and placed to one side surface of the main body 10 in a form capable of wrapping the back of a user's hand to allow the user to easily grip the image photographing apparatus in a photographing operation. The main body 10 includes a zoom button 11 for activating a T/W zoom function and a still image button 13 for photographing a still image on an upper surface thereof. Additionally, the main body 10 includes a motion image button 15 for photographing a motion image and a power switch 17 on a rear surface thereof.

In a high angle photographing operation, the conventional image photographing apparatus as described above is grasped by inserting the user's hand into the hand grip 20 in the form that the back of the user's hand is wrapped therein and then grips the main body 10. Accordingly, user's fingers are in contact with the zoom button 11, still image button 13, and motion image button 15, and thus it is easy to manipulate buttons. To take a comfortable posture while changing into a low angle photographing operation from the high angle photographing operation, the user should remove the user's hand from the hand grip 20 and then again grasp the hand grip 20. Furthermore, to change into the high angle photographing operation from the low angle photographing operation, the user should also remove the user's hand from the hand grip 20 and then again grasp the hand grip 20. Accordingly, a problem may occur in that when the user changes the photographing angle of the image photographing apparatus, it is difficult to continuously photograph. Also, a problem may arise in that, since user's fingers, particularly the forefinger and middle finger, are in contact with a front surface of the main body 10 when changing into a low angle photographing operation from the high angle photographing operation, it is impossible to manipulate the zoom button 11, still image button 13, and motion image button 15 which are placed on the upper and rear surfaces of the main body 10. Additionally, when the buttons are manipulated using the thumb, it is difficult to grip the main body 10 stably.

### SUMMARY OF THE INVENTION

The present general inventive concept provides an image photographing apparatus, which allows a user to photograph freely while changing a position of the user's hand according a photographing angle that the user wants to use while grasping or gripping the apparatus.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an image photographing apparatus including a main body, a first button manipulation unit placed on the main body to be used in a high angle photographing operation, and a second button manipulation unit placed on the main body to be used in a low angle photographing operation.

The first button manipulation unit may be placed on at least one of an upper surface and a rear surface of the main body.

The first button manipulation unit may include a first zoom button to activate a zoom function, a first still image button to photograph a still image, and a first motion image button to photograph a motion image.

The first zoom button and first still image button may be adjacent to each other on the upper surface of the main body.

The first motion image button may be placed on the rear surface of the main body.

The second button manipulation unit may be placed on a front surface of the main body.

The second button manipulation unit may include a second zoom button to activate a zoom function, and a still/motion image button to photograph by selectively switching between a still image and a motion image.

The second button manipulation unit may include a second zoom button to activate a zoom function, a second still image button to photograph a still image, and a second motion image button to photograph a motion image.

The image photographing apparatus may further include a gripping unit placed on the main body.

The gripping unit may be rotatably placed on the main body.

The gripping unit may include a rotary plate rotatably placed on a side surface of the main body, and a gripping band coupled to the rotary plate.

The foregoing and/or other aspects and utilities of the present general inventive concept are also achieved by providing an image photographing apparatus including a main body, a camera unit mounted in the main body to photograph a subject, and a gripping unit rotatably placed on a side surface of the main body. The main body may include first and second still image buttons to photograph a still image, first and second motion image buttons to photograph a motion image, and first and second zoom buttons to zoom the subject in or out.

The foregoing and/or other aspects and utilities of the present general inventive concept are also achieved by providing an image photographing apparatus including a main body, and a camera unit mounted in the main body to photograph a subject. The main body may include first and second image buttons to photograph an image, and first and second zoom buttons to zoom the subject in or out.

The first image button may be placed on a rear surface of the main body, and the second image button may be placed on a front surface of the main body.

The foregoing and/or other aspects and utilities of the present general inventive concept are also achieved by providing an image photographing apparatus, including a main body having a camera unit, and a gripping unit rotatably mounted on the main body to rotate with respect to the main body such that a user can control the camera unit at different angles of the gripping unit with respect to the main body

The image photographing apparatus may further include operating buttons having same functions disposed at a first location and a second location on the main body with respect to the gripping unit.

The user's hand inserted in the gripping unit can be in one of a first and second position corresponding to the first and second locations, and the buttons at the first and second location having the same function are disposed to be controlled by the same finger of the user's hand.

The foregoing and/or other aspects and utilities of the present general inventive concept are also achieved by providing an image photographing apparatus, including a main body having a camera unit, a gripping unit rotatably mounted on the main body to rotate with respect to the main body and to define at least a first and second position on the main body, first and second buttons having the same functionality disposed at the first and second positions, respectively, wherein a user's hand inserted in the griping unit can selectively operate one of the first and second buttons without removing his hand from the gripping unit by rotating his hand with the gripping unit.

The first and second buttons can be disposed within a distance from the gripping unit such that a user's hand inserted into the gripping unit controls the buttons.

The first and second buttons each may include at least one of a zoom button, a still image button, and a motion image button.

The foregoing and/or other aspects and utilities of the present general inventive concept are also achieved by providing an image photographing apparatus, including a main body, a rotatable grip mounted on the main body, to rotate between a first grip position and a second grip position, a first manipulation button disposed on the main body at a position to correspond with the first grip position, and a second manipulation button disposed on the main body at a position to correspond with the second grip position.

The first and second grip positions may correspond to high and low image photographing angles, respectively.

The first manipulation button may include a first zoom button to activate a zoom function, and a first photograph button to photograph an image, and the second manipulation button may include a second zoom button to activate a zoom function, and a second photograph button to photograph an image.

Each of the first and second photograph buttons may include a still image button to photograph a still image and a motion image button to photograph a motion image.

Each of the first and second photograph buttons can be set to photograph one of a still image and a motion image.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a perspective view illustrating a general image photographing apparatus;

FIGS. 2A and 2B are perspective views illustrating an image photographing apparatus according to an exemplary embodiment of the present general inventive concept;

FIG. 3 is a perspective view illustrating an image photographing apparatus according to another exemplary embodiment of the present general inventive concept; and

FIGS. 4A and 4B are views illustrating user's motions according to photographing angles of the image photographing apparatus according to an exemplary embodiment of the present general inventive concept, respectively.

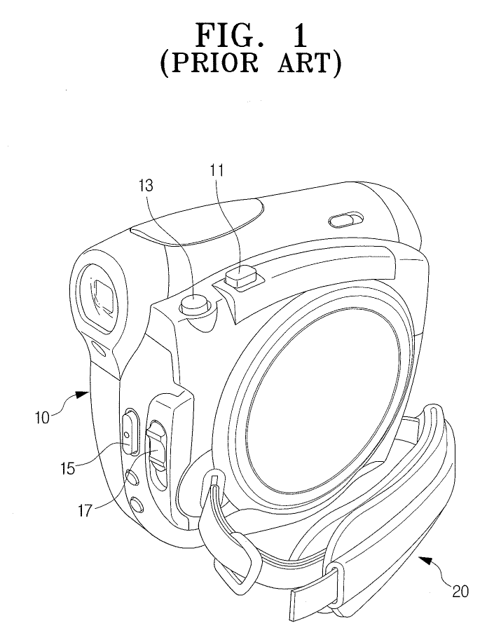

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

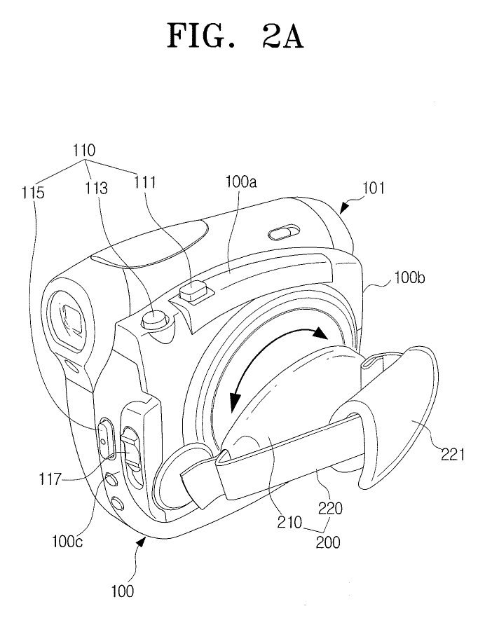

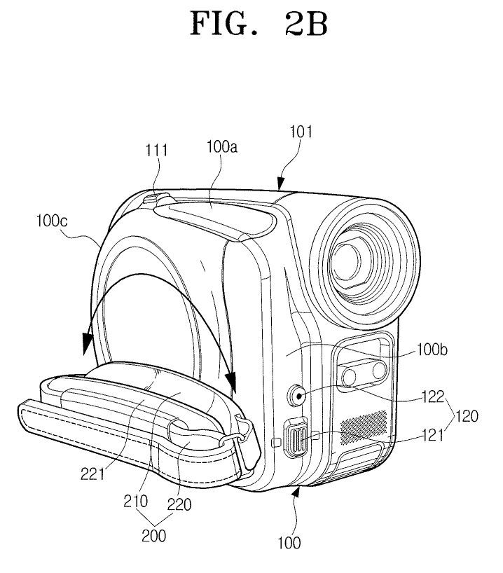

FIGS. 2A and 2B are perspective views illustrating an image photographing apparatus according to an exemplary embodiment of the present general inventive concept.

As illustrated in FIGS. 2A and 2B, the image photographing apparatus according to this exemplary embodiment may include a main body 100, and a griping unit 200 placed on the main body 100.

The main body 100 can be equipped with a camcorder, a motion image camera, and/or a still camera, which are known in the art. The main body 100 may include a first button manipulation unit 110 used in a high angle photographing operation, a second button manipulation unit 120 used in a low angle photographing operation, and a power switch 117.

The first button manipulation unit 110 can be placed on an upper surface 100a and/or a rear surface 100c of the main body 100. The first button manipulation unit 110 may include a first zoom button 111 to activate a T/W zoom function, a first still image button 113 to photograph a still image, and a first motion image button 115 to photograph a motion image. The first zoom button 111 and first still image button 113 may be adjacent to each other on the upper surface 110a of the main body 100, and the first motion image button 115 may be placed on the rear surface 110c of the main body 100.

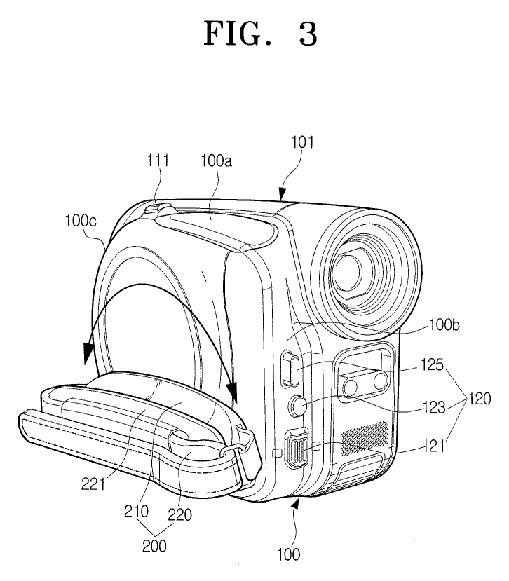

The second button manipulation unit 120 can be placed on a front surface 100b of the main body 100. The front surface 100b may be disposed opposite to the rear surface 100c or facing an object to be photographed. The second button manipulation unit 120 may include a second zoom button 121 to activate the T/W zoom function, and a still/motion image button 122 to photograph by selectively switching between a still image and a motion image. The still/motion image button 122 may be used as a still image button or a motion image button according to a photographing mode of the image photographing apparatus. For example, if the image photographing apparatus is in a still image photographing mode, the still/motion image button 122 may act as a still image button, and if the image photographing apparatus is in a motion image photographing mode, the still/motion image button 122 may act as a motion image button. Alternatively, as illustrated in FIG. 3, in an image photographing apparatus according to another exemplary embodiment of the present general inventive concept, a second button manipulation unit 120 may include a second zoom button 121 to activate the T/W zoom function, a second still image button 123 to photograph a still image, and a second motion image button 125 to photograph a motion image.

The gripping unit 200 may be rotatably placed on the main body 100. The gripping unit 200 may include a rotary plate 210 and a gripping band 220.

The rotary plate 210 is rotatably placed on one side surface of the main body 100. The rotary plate 210 can be placed at a rotary axle (not illustrated), which is an axle that is coupled with the main body 100. The rotary axle can have a gear structure (not illustrated), so that the rotary plate 210 is rotated in intervals of a predetermined angle with respect to the main body 100. The rotary plate 210 can have a thin disk shape. However, the rotary plate 210 according to embodiments of the present general inventive concept is not limited to this shape, but can be formed in other shapes, such as a polygonal plate or the like. For example, the rotary plate 210 may be a conventional structure rotatably coupled to a body to rotate with respect to the body by an angle.

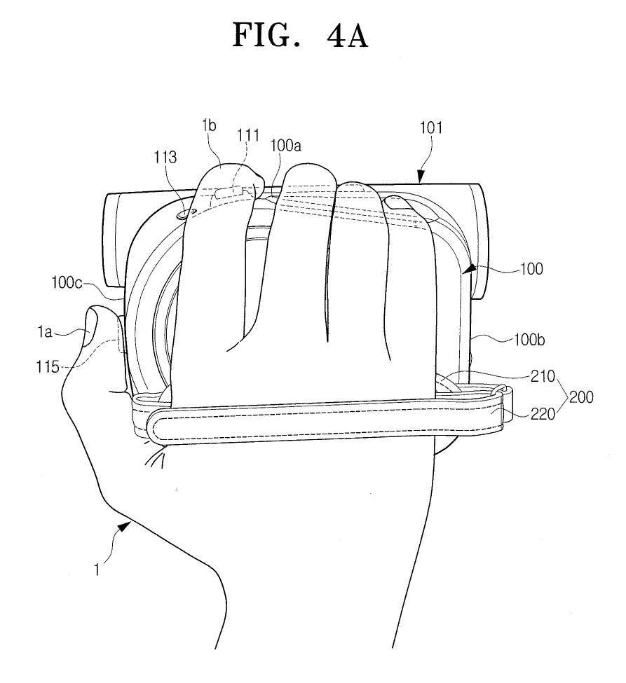

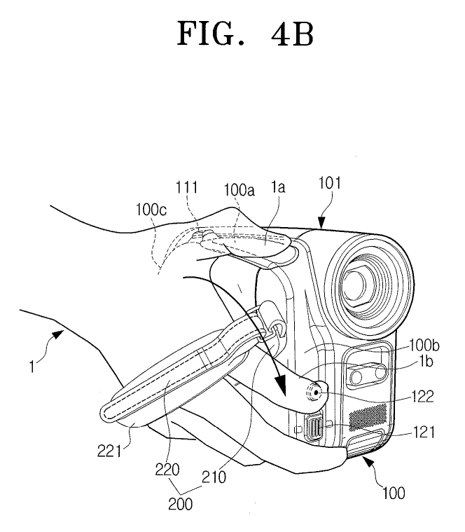

The gripping band 220 can be coupled with the rotary plate 210. The gripping band 220 can adjust a length thereof, so that a user's hand 1 can be securely seated on the main body 100, as illustrated in FIG. 4A. Also, the gripping band 220 may include a subsidiary member 221 to wrap across the back of the user's hand.

An image photographing apparatus to photograph a still image and a motion image, according to another exemplary embodiment of the present general inventive concept may include a main body 100, a camera unit 101 mounted in the main body 100 to photograph a subject, and a gripping unit 200 rotatably placed on one side surface of the main body 100. The main body 100 may include first and second still image buttons 113 and 123 to photograph a still image, first and second motion image buttons 115 and 125 to photograph a motion image, and first and second zoom buttons 111 and 121 to zoom the subject in or out.

An image photographing apparatus according to still another exemplary embodiment of the present general inventive concept may include a main body 100, and a camera unit 101, mounted in the main body 100, to photograph a subject. The main body 100 includes first and second image button to photograph an image, and first and second zoom buttons 111 and 121 to zoom the subject in or out. The first image button can be placed on a rear surface 100c of the main body 100, and the second image button can be placed on a front surface 100b of the main body 100.

In the image photographing apparatus according to the exemplary embodiment of the present general inventive concept constructed as described above, the first button manipulation unit 110 used in a high angle photographing operation, and the second button manipulation unit 120 used in a low angle photographing operation are placed at appropriate positions of the main body 100. Accordingly, it is easy to manipulate the buttons according to the change of the photographing angle between the high angle and low angle.

Specifically, as illustrated in FIG. 4A, in a high angle photographing operation, the main body 100 can be gripped by inserting the user's hand 1 in the gripping band 220 and then adjusting the length of the gripping band 220 according to the size of the user's hand 1. At this time, since user's fingers are in contact with the first button manipulation unit 110, the first zoom button 111 or the first still image button 113 on the upper surface 100a of the main body 100 can be manipulated using the forefinger 1b. In addition, the first motion image button 117 on the rear surface 100c of the main body 100 can be manipulated using the thumb 1a.

As illustrated in FIG. 4B, when a photographing posture is changed to a low angle photographing operation from the high angle photographing operation, a user can rotate the gripping unit 200 with the user's hand 1 inserted in the gripping band 220. Alternatively, when the photographing posture is changed to the high angle photographing operation from the low angle photographing operation, the user can also rotate the gripping unit 200 with the user's hand 1 inserted in the gripping band 220. That is, the user can photograph while freely changing a position of the user's hand 1 according the photographing angle in which the user wants to photograph at, in a condition that a grasping or gripping state of the apparatus is held. If the photographing posture is changed to the low angle photographing operation, the user's fingers may be in contact with the second button manipulation unit 120. Accordingly, the second zoom button 121 or the still/motion image button 122 can be easily manipulated using the forefinger 1b. At this time, if the still/motion image button 122 is repeatedly pressed, a still image and a motion image can be selectively switched to be photographed.

As apparent from the foregoing description, according to the exemplary embodiments of the present general inventive concept, the first button manipulation unit used in a high angle photographing operation, and the second button manipulation unit used in a low angle photographing operation are placed at appropriate positions of the main body. Accordingly, it is easy to manipulate the buttons according to the change of the photographing angle between the high angle and low angle.

Additionally, the user can photograph freely by changing the position of the user's hand according the photographing angle that the user wants to photograph, in the condition that the gripping state to the apparatus is held.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image photographing apparatus, comprising:
a main body;
a first button manipulation unit placed on the main body to be used in a high angle photographing operation; and
a second button manipulation unit placed on the main body to be used in a low angle photographing operation.

2. The apparatus as claimed in claim 1, wherein the first button manipulation unit is placed on at least one of an upper surface and a rear surface of the main body.

3. The apparatus as claimed in claim 2, wherein the first button manipulation unit comprises:
a first zoom button to activate a zoom function;
a first still image button to photograph a still image; and
a first motion image button to photograph a motion image.

4. The apparatus as claimed in claim 3, wherein the first zoom button and first still image button are adjacent to each other on the upper surface of the main body.

5. The apparatus as claimed in claim 4, wherein the first motion image button is placed on the rear surface of the main body.

6. The apparatus as claimed in claim 2, wherein the second button manipulation unit is placed on a front surface of the main body.

7. The apparatus as claimed in claim 6, wherein the second button manipulation unit comprises:
a second zoom button to activate a zoom function;
a second still image button to photograph a still image; and
a second motion image button to photograph a motion image.

8. The apparatus as claimed in claim 6, wherein the second button manipulation unit comprises:
a second zoom button to activate a zoom function; and
a still/motion image button to photograph by selectively switching between a still image and a motion image.

9. The apparatus as claimed in claim 1, further comprising:
a gripping unit placed on the main body.

10. The apparatus as claimed in claim 9, wherein the gripping unit is rotatably placed on the main body.

11. The apparatus as claimed in claim 10, wherein the gripping unit comprises:
a rotary plate rotatably placed on a side surface of the main body; and
a gripping band coupled to the rotary plate.

12. An image photographing apparatus to photograph a still image and a motion image, the apparatus comprising:
a main body;
a camera unit mounted in the main body to photograph a subject; and
a gripping unit rotatably placed on a side surface of the main body,
wherein the main body comprises:
first and second still image buttons to photograph a still image;
first and second motion image buttons to photograph a motion image; and
first and second zoom buttons to zoom the subject in or out.

13. An image photographing apparatus comprising:
a main body; and
a camera unit mounted in the main body to photograph a subject,
wherein the main body comprises:
first and second image buttons to photograph an image; and
first and second zoom buttons to zoom the subject in or out.

14. The apparatus as claimed in claim 13, wherein:
the first image button is placed on a rear surface of the main body, and
the second image button is placed on a front surface of the main body.

15. An image photographing apparatus, comprising:
a main body having a camera unit; and
a gripping unit rotatably mounted on the main body to rotate with respect to the main body such that a user can control the camera unit at different angles of the gripping unit with respect to the main body

16. The image photographing apparatus of claim 15, further comprising:
operating buttons having same functions disposed at a first location and a second location on the main body with respect to the gripping unit.

17. The image photographing apparatus of claim 16, wherein the user's hand inserted in the gripping unit is in one of a first and second positions corresponding to the first and second location, and the buttons at the first and second location having the same function are disposed to be controlled by the same finger of the user's hand.

18. An image photographing apparatus, comprising:
a main body having a camera unit;
a gripping unit rotatably mounted on the main body to rotate with respect to the main body and to define at least a first and second position on the main body;
first and second buttons having the same functionality disposed at the first and second positions, respectively,
wherein a user's hand inserted in the griping unit can selectively operate one of the first and second buttons without removing his hand from the gripping unit by rotating his hand with the gripping unit.

19. The image photographing apparatus of claim 18, wherein the first and second buttons are disposed within a distance from the gripping unit such that a user's hand inserted into the gripping unit controls the buttons.

20. The image photographing apparatus of claim 19, wherein the first and second buttons each comprise at least one of a zoom button, a still image button, and a motion image button.

21. An image photographing apparatus, comprising:
a main body;
a rotatable grip mounted on the main body, to rotate between a first grip position and a second grip position;
a first manipulation button disposed on the main body at a position to correspond with the first grip position; and
a second manipulation button disposed on the main body at a position to correspond with the second grip position.

22. The image photographing apparatus of claim 21, wherein the first and second grip positions correspond to high and low image photographing angles, respectively.

23. The image photographing apparatus of claim 22, wherein:
the first manipulation button comprises:
a first zoom button to activate a zoom function, and
a first photograph button to photograph an image; and
the second manipulation button comprises:
a second zoom button to activate a zoom function, and
a second photograph button to photograph an image.

24. The image photographing apparatus of claim 23, wherein each of the first and second photograph buttons comprises a still image button to photograph a still image and a motion image button to photograph a motion image.

25. The image photographing apparatus of claim 23, wherein each of the first and second photograph buttons can be set to photograph one of a still image and a motion image.
